(19) United States
(12) Patent Application Publication
(10) Pub. No.: US 2022/0205423 A1
(43) Pub. Date: Jun. 30, 2022

(54) ROTOR FOR A WIND TURBINE AND WIND TURBINE

(71) Applicant: Wobben Properties GmbH, Aurich (DE)

(72) Inventors: Jochen STEMBERG, Aurich (DE); Hauke MAASS, Aurich (DE)

(21) Appl. No.: 17/606,672

(22) PCT Filed: Apr. 30, 2020
(86) PCT No.: PCT/EP2020/062027

§ 371 Date: Oct. 26, 2021

(30) Foreign Application Priority Data
Apr. 30, 2019 (DE) 10 2019 111 123.4

(51) Int. Cl. F03D 1/06; F03D 13/20

(52) U.S. Cl. CPC F03D 1/0675; F03D 13/20; F05B 2260/70; F05B 2240/211; F05B 2240/307

(57) ABSTRACT

A rotor for a wind turbine, in particular a wind turbine, having a power of more than 1 MW, to a hub for a rotor of a wind turbine and to a wind turbine. A rotor for a wind turbine, in particular a wind turbine having a power of more than 1 MW, comprising a primary rotor blade, wherein the primary rotor blade extends from a first root region to a first blade tip having a first longitudinal extension, a secondary rotor blade, wherein the secondary rotor blade extends from a second root region to a second blade tip having a second longitudinal extension, the first longitudinal extension being larger than the second longitudinal extension.

### BACKGROUND

### Technical Field

The invention relates to a rotor for a wind turbine, in particular a wind turbine with a power output of more than 1 MW (megawatt), to a hub for a rotor of a wind turbine, and to a wind turbine.

### Description of the Related Art

Wind turbines are well known. Modern wind turbines relate as a rule to what are known as horizontal axis wind turbines, in the case of which the rotor axis is arranged substantially horizontally and the rotor blades sweep over a substantially perpendicular rotor area. In addition to a rotor which is arranged in a nacelle, wind turbines as a rule comprise a tower, on which the nacelle with the rotor is arranged such that it can be rotated about a substantially vertically oriented axis. The rotor as a rule comprises one, two or more rotor blades of equal length. The rotor blades are slim components of identical length which are frequently produced from fiber-reinforced plastic.

In the case of the construction of rotor blades for wind turbines, a compromise has to be found, inter alia, between as great a lift as possible of the rotor blade, the air resistance thereof and the stability of the rotor blade. It is well known that a profile of a rotor blade which generates high lift at low wind speeds as a rule has a high air resistance at higher wind speeds. Moreover, in addition to the aerodynamic properties of the rotor blade, it has to additionally be ensured in the case of the construction that the rotor blade withstands a wind pressure which occurs, for example, in the case of storm. These requirements are as a rule defined as structural requirements. Requirements of this type can as a rule be met more simply with slim rotor blades with thick profiling than with rotor blades with thin profiles, since a predefined stability can be achieved with lower material outlay by way of a thick profile than by way of a thin profile.

The rotor blades of a rotor of a horizontal axis wind turbine are as a rule designed in such a way that they reduce the speed in the flow conduit by ⅓ of the original wind speed, which is also called the Betz optimum efficiency. This reduction is achieved by way of an induction of the rotor counter to the incident flow direction. Accordingly, the optimum rotor opposes the incident air with a resistance which is exactly so great that the incident flow speed on the entire rotor rotational plane is reduced by ⅓. This is also called an induction factor. The induction factor is dependent at every point of a rotor blade on the local circumferential speed, the local coefficient of lift and the rotor blade depth. The energy which is removed from the wind in this way is converted into electricity.

A rotor is as a rule designed for a defined rotational speed or a defined ratio of blade tip speed to incident flow speed, what is known as the tip speed ratio. The coefficients of lift and the rotor blade depth are then selected in such a way that an induction factor of as far as possible ⅓ is set over the entire rotor radius. It has been shown in practice, however, that an induction factor of ⅓ cannot be realized, in particular, in sections of the rotor blade which are close to the hub, but rather usually assumes lower values. This results in a lower power output of the wind turbine in the part load range.

EP 1 255 931 B1 describes a wind turbine with two rotors which are arranged behind one another, one rotor having a first diameter and a further rotor having a second diameter. The rotational speeds of the two rotors are designed in such a way that the blade tips of the rotor blades of said rotors have the same circumferential speeds. In order to achieve this, the rotational speed of the two rotors is different.

The German Patent and Trade Mark Office has searched the following prior art in the priority application in respect of the present application: DE 10 2009 038 076 A1, DE 10 2015 113 404 A1, DE 10 2017 117 843 A1, US 2012/0051916 A1, US 2016/0237987 A1 and WO 2007/057021 A1.

### BRIEF SUMMARY

Provided is a rotor for a wind turbine, in particular a wind turbine with a power output of more than 1 MW (megawatt), a hub for a rotor of a wind turbine, and a wind turbine, which may reduce or eliminate one or more of the abovementioned disadvantages. In particular, provided are techniques which increases the yield of wind turbines in the part load range.

According to a first aspect, provided is a rotor for a wind turbine, in particular a wind turbine with a power output of more than 1 MW, comprising a primary rotor blade, the primary rotor blade extending with a first longitudinal extent from a first root region to a first blade tip, and a secondary rotor blade, the secondary rotor blade extending with a second longitudinal extent from a second root region to a second blade tip, the first longitudinal extent being greater than the second longitudinal extent.

The primary rotor blade extends from the first root region toward the first blade tip. The length of the primary rotor blade between the root region and the first blade tip is, in particular, the longitudinal extent which can be more than 50 m (meters) in the case of modern rotors for wind turbines. The root region is, in particular, that region of the primary rotor blade, with which it is arranged on a hub. The blade tip is that region of the primary rotor blade which faces away from the hub.

In addition to the primary rotor blade, the rotor comprises the secondary rotor blade. The secondary rotor blade differs from the primary rotor blade, in particular, in that it has a smaller longitudinal extent. The length of the secondary rotor blade is therefore smaller than the length of the primary rotor blade. During operation, the difference can also be seen in the fact that the rotating primary rotor blade sweeps over a circular area which has a greater diameter than the circular area which is swept over by the secondary rotor blade.

The rotor which is described in the preceding text is based on the finding that the non-optimum induction factor, which differs from ⅓, in that region of rotor blades which is close to the hub reduces the power output of the wind turbine, in particular in the part load range. It has been found, furthermore, that the required rotor blade depth is dependent on the possible coefficients of lift of the profile sections which are used. Said coefficients of lift cannot be arbitrarily high, but rather are limited by way of aerodynamic, physical limits. As a result, an optimum rotor blade cannot be of arbitrarily slim configuration, but rather a defined minimum blade depth is required in order to achieve the optimum induction factor in the case of a given rotor rotational speed and a given maximum coefficient of lift.

There is the problem in that region of the rotor blade which is close to the hub that the circumferential speed becomes smaller and theoretically tends toward zero at the hub. In order to achieve an optimum induction factor in the case of limited coefficients of lift, the rotor blades would have to be of infinitely deep configuration in the region which is close to the hub. This is not possible from a structural aspect, however. Moreover, the profiles have to absorb high bending torques at the blade root and therefore have to be of thick configuration for structural reasons, as a result of which the coefficients of lift which can be achieved are in turn reduced further. Moreover, a limit of the maximum blade depth which usually lies in the range between 4 m and 5 m is necessary for logistical reasons, in order to ensure that the rotor blades can be transported on the road.

On pitch-controlled wind turbines, the root region of rotor blades as a rule has a circular profile, in order for it to be possible for the rotor blade to be mounted and rotated on the system correspondingly, in particular on a hub. A circular profile of this type has a coefficient of lift of zero, with the result that merely an induction factor which differs from the optimum is possible. Accordingly, owing to the construction, pitch-controlled wind turbines have an induction factor which differs from the optimum in the rotor blade region which is close to the hub, with the result that the power output is reduced further.

Furthermore, the disclosure described herein is based on the finding that a further aerodynamic optimization of conventional rotor blades is not promising. In accordance with this finding, it is provided that a smaller secondary rotor blade is provided in that region of the rotor which is close to the hub. Said secondary rotor blade is an additional rotor blade which, in addition to the primary rotor blade, is preferably arranged on a hub and increases the induction factor of the rotor in the region which is close to the hub.

The second longitudinal extent of the secondary rotor blade preferably conforms to the length of that region on the primary rotor blade, in which the optimum induction factor is not achieved. The secondary rotor blade preferably extends with a second longitudinal extent which is such that it covers that region of the rotor which would not have an optimum induction factor of ⅓ on account of the primary rotor blade.

One advantage of this solution lies in the fact that, owing to the smaller second longitudinal extent, the second root region is subjected only to small bending torques and can correspondingly be configured with a small relative profile thickness. As a result, higher glide ratios can be achieved on the secondary rotor blade than by way of the thick profiles on the primary rotor blade. This achieves a situation where the secondary rotor blade can be operated with an optimum power output in the part load range, in which the system is operated at the design tip speed ratio. Accordingly, the induction factor of ⅓ is achieved substantially as far as the hub.

The rotor which is described in accordance with the first aspect affords a particular advantage, in particular, for weak wind turbines, since the structural design of the primary rotor blades is significant here and the storm loads are less critical for the system design.

It is provided in one preferred design variant of the rotor that the ratio of the second longitudinal extent to the first longitudinal extent is smaller than 0.75, smaller than 0.5, smaller than 0.3, or smaller than 0.1. The secondary rotor blade can be, for example, less than half as long as the primary rotor blade and therefore can have less than 50% of the length of the primary rotor blade. Moreover, it can be preferred that the secondary rotor blade has less than 30% of the length of the primary rotor blade. In particular, it is preferred that the secondary rotor blade has a length of less than or equal to 20 m. As a consequence, special transports can be avoided, and the costs and the organizational complexity are not influenced substantially in comparison with conventional rotors.

It is provided according to a further preferred design variant of the rotor that the primary rotor blade has a pitch adjustment for the rotational movement about a longitudinal axis of the primary rotor blade. Moreover, it is preferred that the secondary rotor blade is of stall-controlled configuration. The stall-controlled secondary rotor blades are preferably fastened fixedly to a hub.

A rotor of this type with a pitch-controlled primary rotor blade and a stall-controlled secondary rotor blade is a hybrid variant between a stall-controlled and a pitch-controlled wind turbine. Furthermore, the secondary rotor blade can also be pitch-controlled and can have a pitch adjustment. If the nominal power output of the wind turbine with this rotor is achieved and the rotor rotational speed cannot be increased further, the primary rotor blade is operated by means of the pitch adjustment with smaller tip speed ratios, which leads to it being possible for a flow separation to begin on the secondary rotor blade. As a result, the induction factor and the torque which is generated by the secondary rotor blade as a rule drop, and the degree of efficiency of the rotor is generally reduced.

This is a desired effect in the case of strong wind, in order that an undesired power output excess can be avoided at the rotor. This facilitates the operation of a system of this type in storm control mode. Since the secondary rotor blade is operated only at small circumferential speeds on account of its small second longitudinal extent, a flow separation on said secondary rotor blade does not represent a significant problem either acoustically or aero-elastically.

It is provided according to a further preferred development of the rotor that the primary rotor blade and the secondary rotor blade are arranged on a hub. The primary rotor blade and the secondary rotor blade are arranged, in particular, on a common hub.

The hub preferably has a primary connector point and a secondary connector point. The primary rotor blade is preferably arranged at the primary connector point. The secondary rotor blade is preferably arranged at the secondary connector point. The primary connector point is preferably configured in such a way that a rotatable arrangement of the primary rotor blade is possible at it. For example, the primary connector point can have a circular flange, on which a bearing is arranged, the primary rotor blade being arranged at the primary connector point such that it can be rotated by way of said bearing.

Moreover, the hub is preferably configured in such a way that pitch drives can be arranged or are arranged on it, with the result that the primary rotor blade can be moved by means of the pitch drives rotationally about its longitudinal axis. The secondary connector point is preferably configured in such a way that the secondary rotor blade can be arranged fixedly at it.

The primary rotor blade and the secondary rotor blade are preferably arranged substantially at the same axial position with regard to a rotor rotational axis. In particular, the primary rotor blade and the secondary rotor blade are arranged such that they cannot substantially be offset with respect to one another with regard to the rotor rotational axis.

It is provided according to a further preferred development of the rotor that the primary rotor blade has a first longitudinal axis which is oriented between the first root region and the first blade tip, and the secondary rotor blade has a second longitudinal axis which is oriented between the second root region and the second blade tip, and the first longitudinal axis and the second longitudinal axis enclose an angle parallel to the rotational direction.

The longitudinal axes of the primary rotor blade and the secondary rotor blade are not parallel by virtue of the fact that the longitudinal axes of the primary rotor blade and the secondary rotor blade enclose an angle parallel to the rotational direction. There is preferably an angle of less than or equal to 90°, in particular of less than or equal to 60°, between the longitudinal axis of the primary rotor blade and the longitudinal axis of the secondary rotor blade. The rotational direction is to be understood to mean the circumferential direction of the blade tips and/or the circular area which the primary rotor blade and/or the secondary rotor blade sweep/sweeps over during operation.

Moreover, it can be preferred that the rotor has a rotational axis, and the first longitudinal axis and the second longitudinal axis enclose substantially an angle of identical magnitude with the rotational axis.

The rotor preferably has the rotational axis. The longitudinal axes of the primary rotor blade and the secondary rotor blade preferably enclose substantially an angle of identical magnitude with the rotational axis. This means, in particular, that the area which is swept over by way of the primary rotor blade during operation comprises substantially that area of the secondary rotor blade which is swept over during operation.

It is provided according to a further preferred design variant of the rotor that the primary rotor blade comprises, in a manner which is adjacent to the first root region, a structural section which, starting from the first root region, extends with a structural section length in the direction of the first blade tip, and the structural section has an induction factor of smaller than 0.3, and/or smaller than 0.25, and/or smaller than 0.2.

The structural section of the primary rotor blade makes a particularly satisfactory structural design of the primary rotor blade possible, since preferably no aerodynamic optimization operations are performed. In particular, the structural section can have a small coefficient of lift or a coefficient of lift of zero. In particular, substantially no high induction factors are taken into consideration in the case of the design of the structural section. This decreases the costs of the primary rotor blade. In particular, the primary rotor blade can also be of stronger design. The structural section is to be understood to mean, in particular, a section of the primary rotor blade, which section is close to the hub.

The primary rotor blade with a structural section with small induction factors will have a smaller degree of efficiency than a primary rotor blade with an optimized induction factor in the region which is close to the hub. Said non-optimum induction factor of the primary rotor blade is compensated for by way of the secondary rotor blade, however. The combination of primary rotor blade with the structural section with a small induction factor and the secondary rotor blade with an optimized induction factor results in a rotor with a higher degree of efficiency in comparison with rotors which have the known optimized rotor blades.

Any desired points along the radial extent of the rotor can be specified in percent, 0% preferably representing the root region and 100% representing the blade tip of the primary rotor blade.

The primary rotor blade preferably has, in the region between 30% and 100%, an induction factor of from 0.25 to 0.4, in particular of from 0.3 to 0.35, particularly preferably of ⅓. Between 30% and 0%, the induction factor can decrease successively and, at 0° (that is to say, in the root region), reaches a value of substantially zero. In the region between 20% and 40%, the primary rotor blade can have an induction factor of greater than ⅓, with the result that excess induction occurs here. In a region, in which the primary rotor blade has excess induction, the secondary rotor blade preferably has a negative coefficient of lift, in order to compensate for the excess induction of the primary rotor blade.

The structural section preferably has a higher relative thickness and a smaller curvature in comparison with conventional rotor blades. A separation can be avoided in this way in the case of relatively small lift. In a section adjoining the root region, the structural section has a geometry which is adapted geometrically to the blade root. The coefficients of lift of the structural section preferably lie between CL=0 and CL=3. It is preferred, in particular, that the coefficients of lift in the region close to the hub, in particular between 0% and 30%, are smaller than those of conventional rotor blades. The blade depth can remain unchanged in comparison with conventional rotor blades.

It is provided according to a further preferred development of the rotor that the second longitudinal extent is greater than the structural section length. If the second longitudinal extent is greater than the structural section length, the secondary rotor blade sweeps over that region of the rotor which, on account of the primary rotor blade, would have a small induction factor, in particular a non-optimum induction factor. As a result of an induction-optimized secondary rotor blade, said region close to the hub, namely the structural section, can be utilized in an optimum manner in relation to induction.

It is provided according to a further preferred design variant of the rotor that the secondary rotor blade has an induction factor between 0 and 0.4, the secondary rotor blade preferably having, in a region adjacent to the second blade tip, an induction factor of smaller than 0.1, for example of 0, and, in a region adjoining the second root region, having an induction factor between 0.25 and 0.4, in particular between 0.3 and 0.35, for example ⅓.

The induction factor which is small or lies at zero at the second blade tip is preferably therefore selected in this way because, in this radius region, the primary rotor blade as a rule has merely a small induction factor deficit, for example of just below ⅓. Therefore, merely a small induction factor deficit has to be compensated for by the secondary rotor blade, with the result that the secondary rotor blade can have a smaller induction factor in this region. The more the induction factor of the primary rotor blade decreases toward the hub, the greater the induction factor of the secondary rotor blade becomes, with the result that the induction factors of the two rotor blades add up to ⅓ at each point of the rotor radius. It is particularly preferred that the local induction factor of the secondary rotor blade is ⅓ minus the local induction factor of the primary rotor blade. For example, the induction factor of the primary rotor blade is 0.15 when 15 m away from the hub. The induction factor of the secondary rotor blade is then preferably 0.18 when 15 m away from the hub, which is approximately the difference of ⅓ and 0.15.

The induction-optimum region of the rotor can be increased by way of a secondary rotor blade which is configured in this way. The rotor can be of induction-optimized configuration, in particular, in the region which is close to the hub. For example, the region with a non-optimum induction factor, that is to say less than ⅓, can be decreased by more than 50% by way of the secondary rotor blade which is described in the preceding text.

It is provided according to a further preferred design variant of the rotor that said rotor comprises two primary rotor blades and/or two secondary rotor blades, the primary rotor blades and the secondary rotor blades being arranged adjacently with respect to one another, and preferably in each case enclosing a 90° angle.

The two primary rotor blades are preferably arranged so as to lie opposite one another on a hub. The two secondary rotor blades are preferably arranged so as to lie opposite one another on the hub. In this preferred design variant of the rotor, the longitudinal axes of the two primary rotor blades are preferably arranged in parallel. The longitudinal axes of the primary rotor blades preferably enclose a 180° angle with one another. The longitudinal axes of the secondary rotor blades preferably likewise enclose a 180° angle with one another. Moreover, it is preferred that a primary rotor blade and a secondary rotor blade enclose an angle of 90° with one another. A rotor of this type is, in particular, of four-blade configuration, two rotor blades being of long configuration and two rotor blades being of short configuration.

It is provided according to a further preferred design variant that said rotor comprises three primary rotor blades and/or three secondary rotor blades, the primary rotor blades and the secondary rotor blades being arranged adjacently with respect to one another, and preferably in each case enclosing a 60° angle.

The primary rotor blades and the secondary rotor blades are preferably arranged in such a way that a secondary rotor blade is arranged in each case between two primary rotor blades. The longitudinal axes of the adjacent primary rotor blades preferably in each case enclose a 120° angle with one another. The longitudinal axes of the adjacent secondary rotor blades preferably likewise in each case enclose a 120° angle with one another. Moreover, it is preferred that a longitudinal axis of a primary rotor blade and a longitudinal axis of a secondary rotor blade which is adjacent with respect to the primary rotor blade enclose an angle of 60° with one another. A rotor of this type is, in particular, of six-blade configuration, three rotor blades being of long configuration and three rotor blades being of short configuration.

The rotor can advantageously be developed by virtue of the fact that at least one high lift system is arranged on the secondary rotor blade, the at least one high lift system comprising or being configured as: slats, slotted caps, Fowler flaps, vortex generators, and/or Gurney flaps.

In accordance with a further aspect, provided is a hub for a rotor of a wind turbine, comprising at least three primary connector points for coupling to primary rotor blades and at least three secondary connector points for coupling to secondary rotor blades.

In accordance with a further aspect, provided is a wind turbine, comprising a tower and a nacelle which is arranged on the tower and has a rotor in accordance with one of the design variants described in the preceding text and/or has a hub in accordance with the design variant described in the preceding text.

For further advantages, design variants and embodiment details of these further aspects and their possible developments, reference is also made to the description made above in respect of the corresponding features and developments of the rotor.

### BRIEF DESCRIPTION OF THE SEVERAL VIEWS OF THE DRAWINGS

Preferred exemplary embodiments will be explained by way of example on the basis of the appended figures, in which:

FIG. 1 shows a diagrammatic view of a wind turbine,

FIG. 2 shows a diagrammatic view of a further wind turbine with diagrammatically illustrated induction factors, and

FIG. 3 shows a diagrammatic view of a wind turbine known in the prior art with diagrammatically illustrated induction factors.

### DETAILED DESCRIPTION

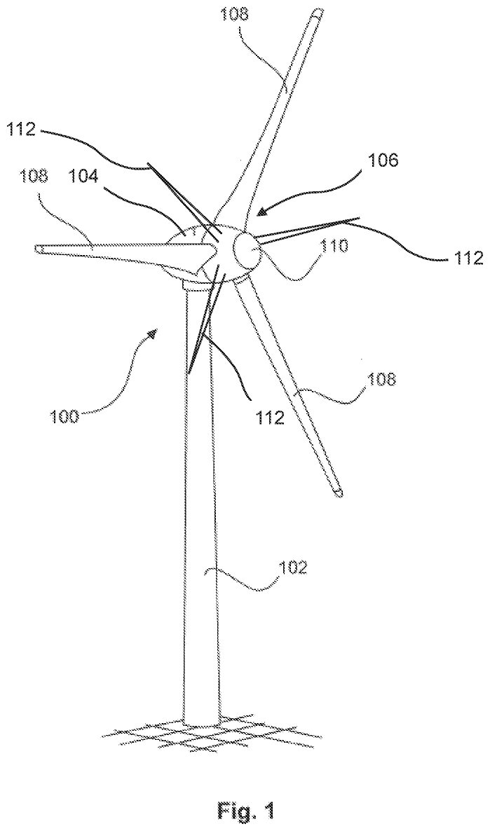

FIG. 1 shows a diagrammatic illustration of a wind turbine. The wind turbine 100 has a tower 102 and a nacelle 104 on the tower 102. An aerodynamic rotor 106 with three primary rotor blades 108 and three secondary rotor blades 112 and a spinner 110 is provided in the nacelle 104. During operation of the wind turbine 100, the aerodynamic rotor 106 is set in a rotational movement by way of the wind, and therefore also rotates an electrodynamic rotor or runner of a generator which is coupled directly or indirectly to the aerodynamic rotor 106. The electric generator is arranged in the nacelle 104 and generates electrical energy. The pitch angles of the primary rotor blades 108 can be changed by way of pitch motors on the rotor blade roots of the respective primary rotor blades 108.

The primary rotor blades 108 preferably have an induction factor of approximately ⅓ in a region beginning at the respective blade tip toward a structural section. In the structural section, the primary rotor blades 108 are designed substantially for meeting structural requirements, and can have an induction factor of considerably below ⅓ here. The secondary rotor blades 112 have a smaller longitudinal extent than the primary rotor blades 108. Moreover, the secondary rotor blades in each case have an induction factor of ⅓ adjacently with respect to the root region, and an induction factor of zero at the blade tip. The sum of the induction factor of the primary rotor blade and of the secondary rotor blade preferably adds up to ⅓ for each distance from the hub. That proportion of the rotor 106, in which the induction factor therefore lies below ⅓, in particular clearly below ⅓, is decreased in the case of the present rotor 106 in comparison with known rotors.

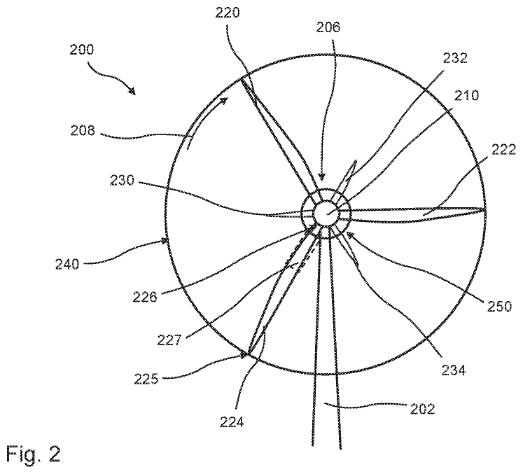

FIG. 2 shows a diagrammatic view of a further wind turbine with diagrammatically illustrated induction factors. The wind turbine 200 has a tower 202 with a rotor 206. The rotor has a spinner 210 in the region of its rotational axis. The rotor comprises a first primary rotor blade 220, a second primary rotor blade 222, and a third primary rotor blade 224. The rotor 206 rotates about a rotational axis, with the result that the primary rotor blades 220, 222, 224 move in the rotational direction 208.

The construction of a primary rotor blade will be explained in the following text using the example of the third primary rotor blade 224. The third primary rotor blade 224 extends from a blade tip 225 toward a root region 226. The blade tip and the root region are to be understood, in particular, to be ends of the third primary rotor blade 224.

In a region close to the hub of the third primary rotor blade 224, the latter has a structural section 227 which, starting from the root region 227, extends with a structural section length in the direction of the blade tip 225 and is shown using dashed lines in the present case. The structural section 227 is distinguished by the fact that it has a small induction factor. In particular, the induction factor of the structural section 227 can be smaller than 0.3 and/or smaller than 0.25 and/or smaller than 0.2.

That section of the third primary rotor blade 224 which adjoins the structural section 227 in the direction of the blade tip 225 preferably has an induction factor of approximately ⅓. In particular, the induction factor in this region can be between 0.25 and 0.5, in particular between 0.25 and 0.35. In a section which adjoins the blade tip 225, the third primary rotor blade 224 therefore has a substantially optimum induction factor which makes optimum-power operation of the wind turbine 200 possible. In a region close to the hub, in particular in a radius which corresponds to the structural section length 227, the primary rotor blades 220, 222, 224 are not of optimum-induction design, however.

Furthermore, the rotor 206 has the first secondary rotor blade 230, the second secondary rotor blade 232 and the third secondary rotor blade 234. The secondary rotor blades 230, 232, 234 have a considerably smaller longitudinal extent than the primary rotor blades 220, 222, 224. At the respective blade tip, the secondary rotor blades 230, 232, 234 have an induction factor of zero which then rises successively toward the root region to a value of from 0.25 to 0.35, in particular ⅓.

The root regions of the secondary rotors 230, 232, 234 are subjected to smaller bending torques due to the considerably smaller longitudinal extent. As a consequence, they can be configured with a smaller relative profile thickness, and therefore higher glide ratios can be achieved. Therefore, the region of a non-optimum induction factor migrates in the direction of the hub, and the overall region of an optimum induction factor is increased. This is shown diagrammatically in FIG. 2 on the basis of the first induction factor region 240 and the second induction factor region 250. The first induction factor region 240 is that region of the rotor or the rotor blades, in which a substantially optimum induction factor, in particular of ⅓, is achieved. The second induction factor region 250 is that region of the rotor 206 or the rotor blades, in which there is a deviation from the optimum induction factor; here, in particular, the induction factor is smaller than ⅓.

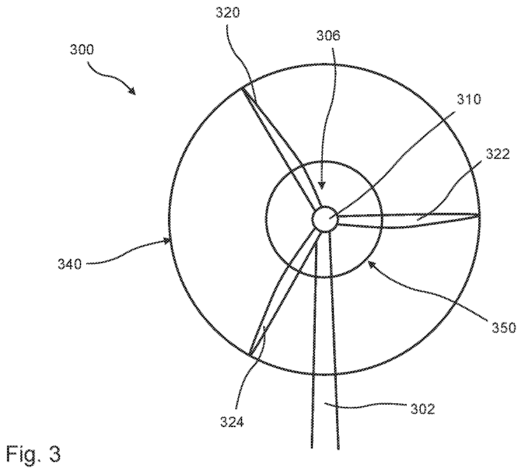

In comparison with this, FIG. 3 shows a conventional wind turbine 300 with a tower 302 and a rotor 306, the rotor having a first rotor blade 320, a second rotor blade 322 and a third rotor blade 324. The rotor 306 does not have any secondary rotor blades. It can be seen that a considerably larger second induction factor region 350 is produced by way of that region of the rotor blades 320, 322, 324 which is close to the hub, in which second induction factor region 350 an optimum induction factor of ⅓ is not achieved. The first induction factor region 340, in which an optimum induction factor can be achieved, is correspondingly smaller. As a consequence, the aerodynamic performance of the rotor 306 is lower than the aerodynamic performance of the rotor 206 from the wind turbine 200 which is shown in FIG. 2.

### LIST OF DESIGNATIONS

100 Wind turbine
102 Tower
104 Nacelle
106 Rotor
108 Primary rotor blades
110 Spinner
112 Secondary rotor blades
200 Wind turbine
202 Tower
206 Rotor
208 Rotational direction
210 Spinner
220 First primary rotor blade
222 Second primary rotor blade
224 Third primary rotor blade
225 Blade tip
226 Root region
227 Structural section
230 First secondary rotor blade
232 Second secondary rotor blade
234 Third secondary rotor blade
240 First induction factor range
250 Second induction factor range
300 Wind turbine
302 Tower
306 Rotor
310 Spinner
320 First rotor blade
322 Second rotor blade
324 Third rotor blade
340 First induction factor region
350 Second induction factor region

1. A rotor for a wind turbine, comprising:
a primary rotor blade, the primary rotor blade extending with a first longitudinal extent from a first root region to a first blade tip, and
a secondary rotor blade, the secondary rotor blade extending with a second longitudinal extent from a second root region to a second blade tip,
the first longitudinal extent being greater than the second longitudinal extent.

2. The rotor as claimed in claim 1, wherein a ratio of the second longitudinal extent to the first longitudinal extent is less than 0.75.

3. The rotor as claimed in claim 1, wherein:
the primary rotor blade has a pitch adjustment for rotational movement about a longitudinal axis of the primary rotor blade, and
the secondary rotor blade has a pitch adjustment for rotational movement about a longitudinal axis of the secondary rotor blade.

4. The rotor as claimed in claim 1, wherein the primary rotor blade and the secondary rotor blade are coupled to a hub.

5. The rotor as claimed in claim 1, wherein:
the primary rotor blade has a first longitudinal axis which ii oriented between the first root region and the first blade tip, and wherein the secondary rotor blade has a second longitudinal axis oriented between the second root region and the second blade tip, and
the first longitudinal axis and the second longitudinal axis enclose an angle parallel to the rotational direction, and/or
the rotor has a rotational axis, and wherein the first longitudinal axis and the second longitudinal axis enclose substantially an angle of identical magnitude with the rotational axis.

6. The rotor as claimed in claim 1, wherein the primary rotor blade comprises a structural section starting from the first root region and extends with a structural section length in a direction of the first blade tip, and wherein the structural section has an induction factor that is less than 0.3.

7. The rotor as claimed in claim 6, wherein the second longitudinal extent is greater than the structural section length.

8. The rotor as claimed in claim 1, wherein the secondary rotor blade has an induction factor between 0 and 0.4.

9. The rotor as claimed in claim 1, comprising two primary rotor blades and two secondary rotor blades, the two primary rotor blades and the two secondary rotor blades being arranged adjacently with respect to one another, and in each case enclosing a 90° angle.

10. The rotor as claimed in claim 1, comprising three primary rotor blades and three secondary rotor blades, the three primary rotor blades and the three secondary rotor blades being arranged adjacently with respect to one another, and in each case enclosing a 60° angle.

11. The rotor as claimed in claim 1, wherein at least one high lift system is arranged on the secondary rotor blade, the at least one high lift system comprising or configured as one or more of:
a plurality of slats,
a plurality of slotted caps,
a plurality of Fowler flaps,
a plurality of vortex generators, and/or
a plurality of Gurney flaps.

12. A hub comprising:
the rotor as claimed in claim 1,
at least three primary connector points configured for coupling with primary rotor blades, including the primary rotor blade, and
at least three secondary connector points configured for coupling to secondary rotor blades, including the secondary rotor blade.

13. A wind turbine, comprising a tower, and a nacelle arranged on the tower, wherein the nacelle includes the rotor as claimed in claim 1.

14. The rotor as claimed in claim 1, wherein the wind turbine has a power output of more than 1 megawatt (MW).

15. The rotor as claimed in claim 2, wherein the ratio is less than 0.1

16. The rotor as claimed in claim 3, wherein the secondary rotor blade provides a stall-controlled configuration.

17. The rotor as claimed in claim 6, wherein the induction factor is less than 0.2.

18. The rotor as claimed in claim 8, wherein the secondary rotor blade has, in a region adjacent to the second blade tip, an induction factor of less than 0.1, and, in a region adjoining the second root region, an induction factor between 0.25 and 0.4.
